(19) United States
(12) Patent Application Publication
(10) Pub. No.: US 2003/0201304 A1
(43) Pub. Date: Oct. 30, 2003

(54) Transport apparatus with a gripper for the transport of substrates

(76) Inventors: Dominik Hartmann, Hagendorn (CH); Reto Schubiger, Ebikon (CH)

Correspondence Address: DAVID B. RITCHIE, THELEN REID & PRIEST LLP, P.O. BOX 640640, SAN JOSE, CA, 95113, US

(21) Appl. No.: 10/417,837

(22) Filed: Apr. 16, 2003

(30) Foreign Application Priority Data
Apr. 30, 2002 (CH) 2002 0733/02

(51) Int. Cl. B23K 37/00

(52) U.S. Cl. 228/49.1; 228/49.5; 228/4.1

(57) ABSTRACT

A transport apparatus comprises a gripper for the transport of substrates. The gripper has a plate on the underside of which the vacuum grippers can be attached magnetically. The plate preferably consists of steel and each vacuum gripper has a permanent magnet. The transport apparatus is suitable for use on a Die Bonder.

### PRIORITY CLAIM

The present application claims priority under 35 U.S.C § 119 based upon Swiss Patent Application No. 2002 0733/02 filed on Apr. 30, 2002.

### FIELD OF THE INVENTION

The invention concerns a transport apparatus with a gripper for transporting substrates.

### BACKGROUND OF THE INVENTION

Such a transport apparatus is suitable for use on an automatic assembly machine for the mounting of semiconductor chips onto a substrate, a so-called Die Bonder. The transport apparatus serves to remove substrates one by one from a stack and to supply them to a second transport apparatus that supplies the substrates in steps to a dispensing or soldering station and a bonding station. The transport apparatus has a gripper with several vacuum grippers which pick up and transport the substrate with vacuum. As substrates, so-called leadframes are often used. Leadframes are structured metal strips with numerous recesses and holes and the problem is presented that the vacuum grippers can in fact apply suction to the leadframes.

A transport apparatus is known with which the vacuum grippers are mounted on two parallel rods whereby the distance between the rods can be altered and whereby the vacuum grippers can be positioned at any position along the rods. This solution is mechanically very complex.

### BRIEF DESCRIPTION OF THE INVENTION

The object of the invention is to develop an inexpensive gripper with which the position of the vacuum grippers can be easily adapted to the structure of a leadframe.

A transport apparatus in accordance with the invention distinguishes itself in that the gripper has a plate on the underside of which the vacuum grippers (also called suction grippers) can be attached magnetically, i.e. by means of magnetic forces. The plate is preferably detachably secured to the transport apparatus so that the position of the vacuum grippers can be conveniently adapted to the structure of the substrate to be processed.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale.

In the drawings:

FIG. 1 shows a transport apparatus with a gripper with a vacuum gripper attachable to a steel plate for the transport of substrates,

FIG. 2 shows a cross-section of such a vacuum gripper,

FIG. 3 shows an underside of the steel plate, and

FIG. 4 shows a Die Bonder with such a transport apparatus.

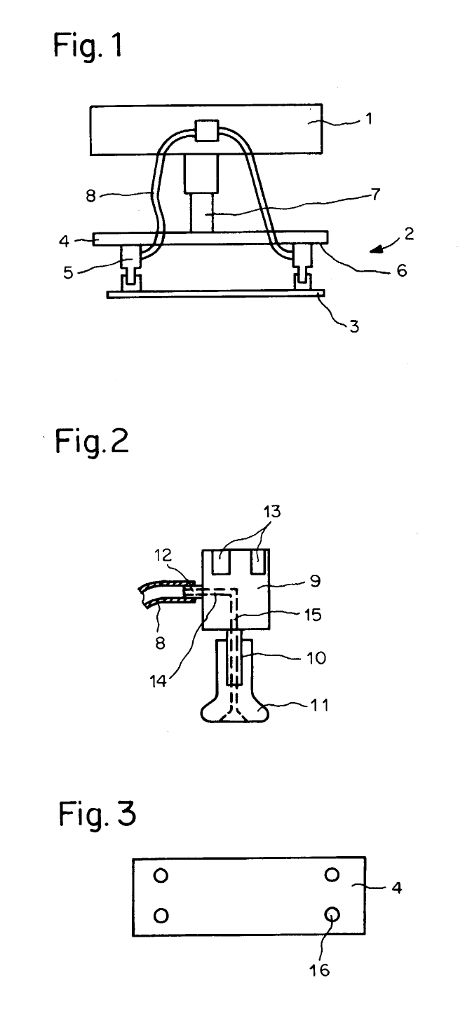

FIG. 1 shows a cross-section of a transport apparatus 1 with an exchangeable gripper 2 for the transport of substrates 3. The transport apparatus 1 is part of a Die Bonder. The transport apparatus 1 serves to remove one substrate 3 after the other from a stack and to supply them to a further transport apparatus, which feeds the substrates 3 in steps to a dispensing or soldering station where adhesive or solder is applied and a bonding station where a semiconductor chip is deposited. The transport apparatus 1 is set up to lower the gripper 2 in order to remove a substrate 3 from the stack, to raise it, to transport it in a predefined direction and then lower it again. The gripper 2 comprises a plate 4 made of steel with several vacuum grippers 5 (sometimes called suction grippers) which can be magnetically attached to an underside 6 of the steel plate 4. The steel plate 4 has a bolt 7 which, by means of a quick-release lock, can easily be attached to the transport apparatus 1. The transport apparatus 1 further comprises hoses 8, to which vacuum can be supplied from a vacuum connection, which can be connected to the vacuum grippers 5 in the manner described below.

FIG. 2 shows a cross-section of one of the vacuum grippers 5. The vacuum gripper 5 comprises a cylindrical shaped body 9 with a protruding connection 10 for accepting a rubber part 11 and a nipple 12 arranged laterally for connection of a hose 8 to which vacuum can be applied, as well as at least one permanent magnet 13 inserted in the body 9. In the example, three permanent magnets 13 are inserted in the body 9. The body 9 has two drill holes 14 and 15 running orthogonally to each other which connect the nipple 12 and the connection 10. The permanent magnets 13 are positioned in the body 9 outside the area of the two drill holes 14 and 15. The body 9 can be inexpensively manufactured as a turned part. The rubber part 11, known in technical jargon as rubber tool, represents the suction organ with which the substrate is really held.

Such a vacuum gripper 5 can be positioned at any position on the underside 6 of the steel plate 4. The permanent magnets 13 stick to the steel plate 4 with a relatively strong force which can amount to up to 20 N.

Instead of three permanent magnets 13, one single, so-called pot magnet can be used. A suitable pot magnet is available for example from Maurer Magnetic under the designation M 491 A. Such a pot magnet comprises a flat bar magnet and a yoke made of soft iron in order to achieve an optimum course of the magnetic field.

On setting up the transport apparatus for the processing of a new substrate, a corresponding number of typically four or even more vacuum grippers 5 can be placed on the underside 6 of the steel plate 4 removed from the transport apparatus, whereby their positions are exactly adapted to the structure of the substrate 3. Afterwards, the steel plate 4 is attached to the transport apparatus. Then, one of the hoses 8 to which vacuum can be applied is pushed onto the nipple 12 of each of the vacuum grippers 5. The transport apparatus is now ready for operation.

The invention enables an inexpensive adaptation of the transport apparatus to different substrate types. In event that a user of the Die Bonder very often processes specific substrate types, then it is possible to foresee a specific steel plate 4 for each substrate type, whereby these steel plates 4 have a number of recesses 16 corresponding to the respective number of necessary vacuum grippers 5 into which the vacuum grippers 5 can be inserted with an exact fit. The vacuum grippers 5 are then automatically correctly positioned. The underside 6 of a steel plate 4 with recesses 16 of this type is shown in FIG. 3.

Because the invention consists of securing the vacuum grippers 5 to the plate 4 magnetically, i.e. by magnetic forces, the alternative is also possible with which the plate is made of ferromagnetic material and is magnetised so that it represents a permanent magnet and with which at least one part of the vacuum grippers facing towards the plate is made of steel. With this alternative, the vacuum grippers do not contain any permanent magnets.

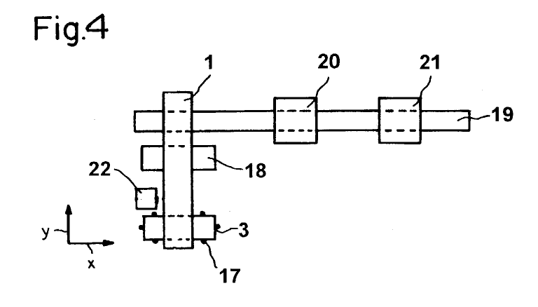

The invented transport apparatus is suitable for use on an apparatus for mounting semiconductor chips on a substrate, a so-called Die Bonder. FIG. 4 shows schematically a plan view of a Die Bonder, as far as is necessary for understanding the invention. The Die Bonder comprises a loading station 17 where substrates 3 to be equipped with semiconductor chips are presented. In the example, the substrates 3 are stacked one on top of the other. In addition, the Die Bonder comprises a trash container 18, a second transport apparatus 19, a dispensing or soldering station 20, a bonding station 21 and a sensor 22. The gripper 2 (FIG. 1) of the transport apparatus 1 is moveable backwards and forwards in a y direction. The gripper 2 removes one substrate 3 after the other from the loading station 17 and transports the gripped substrate 3 in y direction thereby passing the sensor 22. The sensor 22 determines whether the gripper 2 has gripped only one substrate 3 as it should or whether the gripper 2 has gripped more than one substrate 3 which is wrong. Depending on the output signal of the sensor 22 the gripper 2 passes the substrate 3 on to either the trash container 18 (if the sensor 22 has detected more than one substrate 3) or the second transport apparatus 19 (if the sensor 22 has detected one substrate 3). The second transport apparatus 19 transports the substrates 3 in steps in a x direction to the dispensing or soldering station 20 where a portion of adhesive or solder is applied and to the bonding station 21 where a semiconductor chip is bonded.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A transport apparatus with a gripper for the transport of substrates, the gripper comprising a plate and several vacuum grippers, the vacuum grippers magnetically fixed to the plate.

2. Transport apparatus according to claim 1, wherein the plate is made of steel and wherein each vacuum gripper contains at least one permanent magnet.

3. Transport apparatus according to claim 1, wherein the plate is magnetic and wherein at least a part of the vacuum grippers facing towards the plate is made of steel.

4. Transport apparatus according to claim 2, wherein the plate has a plurality of recesses, each recess adapted for accepting one of the vacuum grippers.

5. Transport apparatus according to claim 3, wherein the plate has a plurality of recesses, each recess adapted for accepting one of the vacuum grippers.

6. Transport apparatus according to claim 1, wherein the plate is detachably secured to the transport apparatus.

7. Transport apparatus according to claim 2, wherein the plate is detachably secured to the transport apparatus.

8. Transport apparatus according to claim 3, wherein the plate is detachably secured to the transport apparatus.

9. Transport apparatus according to claim 4, wherein the plate is detachably secured to the transport apparatus.

10. Die Bonder with the transport apparatus according to claim 1.

11. Die. Bonder with the transport apparatus according to claim 2.

12. Die Bonder with the transport apparatus according to claim 3.
